(19) United States
(12) Patent Application Publication
(10) Pub. No.: US 2008/0165800 A1
(43) Pub. Date: Jul. 10, 2008

(54) METHOD AND APPARATUS TO PROVIDE DYNAMIC COST OF CONTEXT SWITCH TO APPLICATION FOR PERFORMANCE OPTIMIZATION

(76) Inventors: Wen-Tzer T. Chen, Austin, TX (US); Men-Chow Chiang, Austin, TX (US); William A. Maron, Austin, TX (US); Mysore S. Srinivas, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/621,215

(22) Filed: Jan. 9, 2007

(51) Int. Cl. H04J 3/22

(52) U.S. Cl. 370/465; 370/401

(57) ABSTRACT

A mechanism is provided in the operating system for recording context switch times. The operating system, the application, or the resource also includes a mechanism for recording response times. At the time of a request, the operating system may compare an average context switch time to an average response time corresponding to the request. The operating system may then decide whether to perform a context switch based on the comparison. Alternatively, the application may receive the average context switch time from the operating system and compare the average context switch time to an average response time corresponding to the request. The application may then decide whether to relinquish the processor or spin on the lock based on the comparison.

### BACKGROUND

1. Technical Field

The present application relates generally to an improved data processing system and method. More specifically, the present application is directed to a method, apparatus, and computer program product to provide dynamic cost of context switch to application for performance optimization.

2. Description of Related Art

Multithreading, also referred to as multitasking, allows a processor to behave as two or more “logical” processors. “Multithreading” here refers to the generic meaning of allowing multiple software threads active in a computer system, where a thread may be a process or one of the threads that belong to a process. In particular, the usage here is not the same as in “hardware multithreading” such as simultaneous multithreading (SMT), where hardware implementation of a processor or processor core allows multiple hardware threads to run on a physical processor (core) at the same time.

A logical processor is a processor as seen from the perspective of the operating system. That is, an operating system may assign threads to a plurality of logical processors, even though it only has access to one physical processor. In multithreading, the operating system swaps threads in and out of the physical processor. These threads then access the physical resources of the system for a period of time before relinquishing the resources to the other thread. To a human observer, the threads, which may be parts of the same application or separate applications, appear to be executing simultaneously.

Swapping threads requires a “context switch.” Each time an application is given access to the processor, it must execute perhaps 1000-2000 instructions, or perhaps more depending on the complexity of the application, to load values into registers, etc. This is referred to as a “context switch.” Also, since another application previously had access to the processor and its associated resources, that other application may have filled the hardware cache with data that would not be useful for the current application. This typically results in a period of hardware cache misses until the current application fills the hardware cache with data that are more likely to be relevant. Thus, a context switch has an associated cost.

When the operating system or an application requests service from a device, the response time from the device may vary. The device may be a portion of storage, a range of memory addresses, an input/output device, etc. As an example, the device may simply be a high latency device that naturally has a longer response time. As another example, the device may be a portion of storage that uses file and record locking.

A “lock” is usually used to implement a data sharing mechanism, such as enforcing first-come, first-served, exclusive access of data. The first user, such as a thread, application, or operating system, to access the file or record prevents, or locks out, other users from accessing the file or record. After the user finishes accessing the file or record, the resource is unlocked and available. File and record locking is an essential part of every database management system, document management system, and any other system that allows data to be updated by multiple users or applications. A lock manager is software or a device that provides file and record locking for multiple computer systems or processors that share a single database.

Thus, an application may request access to a file or record, for example, and wait for the resource to become “unlocked,” as described above. In this case, the application is said to “spin” on the lock. That is, the application executes one or more loops, which may be nested, and periodically checks on the state of the lock. In this case, the response time, the time to actually gain access to the resource, may be relatively long.

If the response time is very long, it may be more efficient for the operating system to perform a context switch. In this case, another application may use the processor while the requesting application waits for a response. However, in other instances, the response time is relatively short, and, thus, a context switch would be too costly and inefficient.

One known solution is to always have an application that makes a request for a resource hold the processor, while another solution is to have a requesting application always relinquish the processor. The application developer may make a best guess about response times to attempt to achieve the best performance. However, the application developer cannot always envision all the combinations of software/hardware configurations in future environments. In fact, the application developer cannot provide a one-size-fits-all design decision for all existing configurations where some may favor a context switch and other configurations may favor the application holding the processor.

A further solution may be to have the requesting application hold the processor for a short time, and if a response is not received in that time, the application may relinquish the processor. This solution may limit the cycles that are wasted for waiting at the processor, but pays a fixed overhead in processor cycles if a context switch is eventually needed. Therefore, this solution suffers from a similar problem to the static decision described above. The initial wait time of the requester while holding the processor should be tuned based on the relative times of the device service and the context switch, and this can be highly variable and difficult to predict.

### SUMMARY

The illustrative embodiments recognize the disadvantages of the prior art and provide a mechanism in the operating system for recording context switch times. The operating system, the application, or the resource also includes a mechanism for recording response times. At the time of a request, the operating system may compare an average context switch time to an average response time corresponding to the request. The operating system may then decide whether to perform a context switch based on the comparison. Alternatively, the application may receive the average context switch time from the operating system and compare the average context switch time to an average response time corresponding to the request. The application may then decide whether to relinquish the processor or spin on the lock based on the comparison.

In one illustrative embodiment, a method for performing dynamic context switch determination comprises determining an average context switch time, determining an average response time, responsive to a first application running on a processor making a request for a resource, comparing the average context switch time to the average response time, and determining whether to perform a context switch from the first application to a second application based on a result of the comparison.

In one exemplary embodiment, determining an average context switch time comprises calculating a running average or a weighted average of recorded context switch times. In another exemplary embodiment, determining an average response time comprises calculating a running average or a weighted average of recorded context switch times.

In a further exemplary embodiment, the method further comprises responsive to determining to perform a context switch, granting access to the processor to the second application, and recording a context switch time for the context switch. In a still further exemplary embodiment, the method further comprises updating the average context switch time based on the recorded context switch time.

In another exemplary embodiment, the method further comprises responsive to a response being received from the resource, granting access to the processor back to the first application, and recording a response time for the response. In a further exemplary embodiment, the method further comprises updating the average response time based on the recorded response time.

In yet another exemplary embodiment, the method further comprises responsive to determining to perform a context switch, the first application relinquishing the processor. In a further exemplary embodiment, the method further comprises responsive to determining not to perform a context switch, the first application waiting for a response.

In another illustrative embodiment, an apparatus is provided for performing dynamic context switch determination. The apparatus comprises a processor and a memory coupled to the processor. The memory contains instructions that, when executed by the processor, cause the processor to obtain an average context switch time, obtain an average response time, responsive to a first application running on a processor making a request for a resource, compare the average context switch time to the average response time, and determine whether to perform a context switch from the first application to a second application based on a result of the comparison.

In other exemplary embodiments, the instructions cause the processor to perform various ones, and combinations of, the operations outlined above with regard to the method illustrative embodiment.

In a further illustrative embodiment, a computer program product comprises a computer useable medium having a computer readable program. The computer readable program, when executed on a computing device, causes the computing device to obtain an average context switch time, obtain an average response time, responsive to a first application running on a processor making a request for a resource, compare the average context switch time to the average response time, and determine whether to perform a context switch from the first application to a second application based on a result of the comparison.

In other exemplary embodiments, the computer readable program, when executed on a computing device, causes the computing device to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2 is a block diagram of an exemplary data processing system in which aspects of the illustrative embodiments may be implemented;

FIG. 3 is a block diagram illustrating a data processing system with multithreading;

FIG. 4 is a block diagram illustrating a data processing system with multithreading and dynamic context switching decision logic in accordance with an illustrative embodiment;

FIG. 5 is a flowchart illustrating operation of an operating system with dynamic context switch decision logic in accordance with an illustrative embodiment; and

FIG. 6 is a flowchart illustrating operation of an application with dynamic context switch decision logic in accordance with an illustrative embodiment.

### DETAILED DESCRIPTION OF THE ILLUSTRATIVE EMBODIMENTS

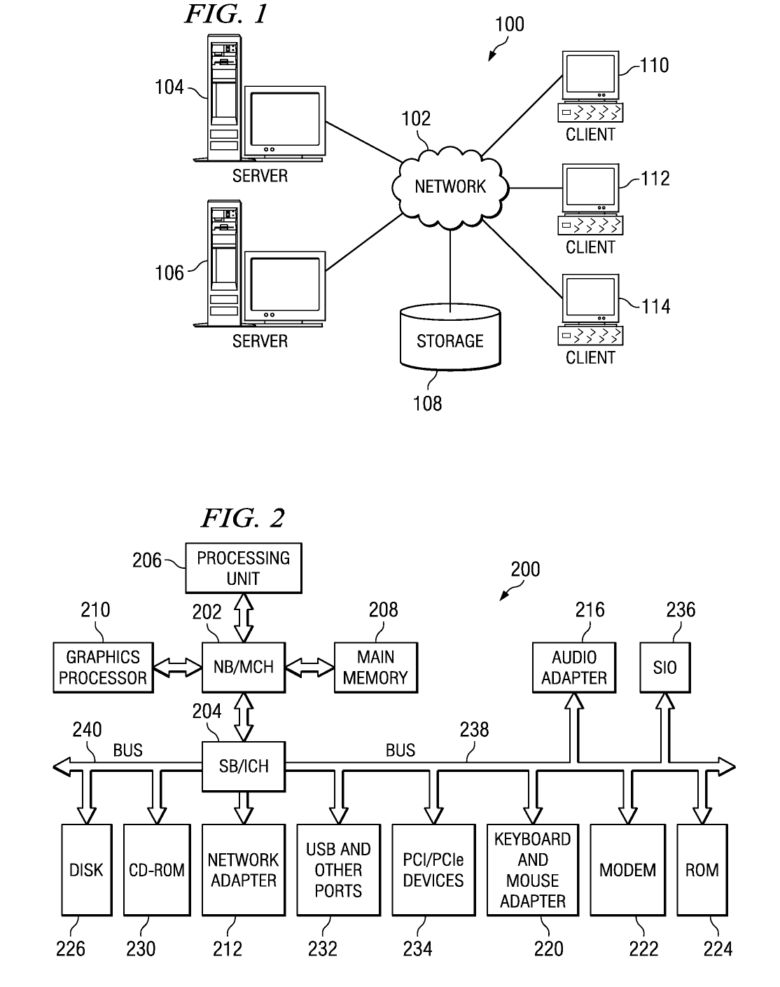

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In accordance with the illustrative embodiments, one or more of clients 110-114 and servers 104, 106 may use multithreading to execute two or more applications using a single physical processor. The operating system running on a data processing system, such as one of clients 110-114 or servers 104, 106, may perform a context switch from one application to another. Alternatively, an application may relinquish a processor, in which case the operating system then gives another application access to the processor. A physical processor may be a whole processor or a core of a multiple-core processor or system on a chip.

When the operating system or an application requests service from a device, the response time from the device may vary. The device may be a portion of storage, a range of memory addresses, an input/output device, etc. As an example, the device may simply be a high latency device that naturally has a longer response time.

As another example, the device may be a portion of storage that uses file and record locking. For instance, an application running on server 106 may request to read from or write to a record in a database management system maintained at server 104. In this case, server 104 may include a lock manager that receives requests from users, grants or denies access to users, and maintains locks on files or records. Thus, a first user, an application running on client 112, may access a particular record, and a lock manager at server 104 may change the state of the lock associated with the record to “locked.” When a second user, an application running on server 106, attempts to access that record, the lock manager at server 104 may respond to the request with the state of the lock. The application at server 106 may spin on the lock until the application at client 112 is finished accessing the record.

In the above example, the application executing at server 106 may experience a relatively long service time. Rather than having the application hold the processor while spinning on the lock, the operating system at server 106 may perform a context switch, giving access to the processor to another application. A context switch has an associated cost. It is difficult to always make the correct decision about whether to perform a context switch or to allow the requesting application to hold the processor.

In accordance with an illustrative embodiment, a mechanism is provided in the operating system for recording context switch times. The operating system, the application, or the resource also includes a mechanism for recording response times. At the time of a request, the operating system may compare an average context switch time to an average response time corresponding to the request. The operating system may then decide whether to perform a context switch based on the comparison. Alternatively, the application may receive the average context switch time from the operating system and compare the average context switch time to an average response time corresponding to the request. The application may then decide whether to relinquish the processor or spin on the lock based on the comparison.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like.

As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as hosts 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a hardware cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

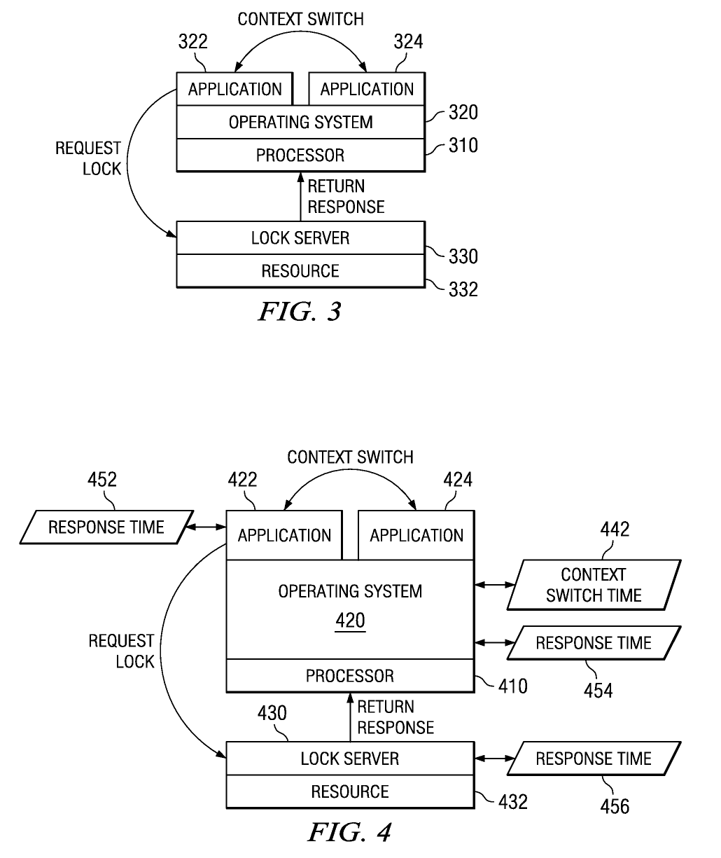

FIG. 3 is a block diagram illustrating a data processing system with multithreading. Operating system 320 executes applications 322, 324 on processor 310. Using multithreading, operating system 320 swaps applications 322, 324 by performing a context switch. For example, application 322 may execute on processor 310 for a period of time, and then operating system 320 may perform a context switch so that application 324 executes on processor 310.

Operating system 320 may perform multitasking by giving each thread, or application, a time slice of processor 310. To the operator, it would appear that application 322 and application 324 are executing simultaneously.

Performing a context switch has an associated cost. For example, application 322 may execute 1000-2000 instructions, or perhaps more, as initialization operations, such as loading registers, etc. As application 322 executes on processor 310, it may load data in the hardware cache (not shown). When operating system 320 performs a context switch, application 322 may perform a number of instructions to complete a unit of work, application 324 performs initialization operations, such as loading registers. Furthermore, application 324 may experience an initial period of time with a high number of cache misses as it loads data relevant to application 324 into hardware cache.

In the depicted example, application 322 submits a request for a lock of resource 332 to lock server 330. Resource 332 may be, for example, a range of memory addresses, an input/output device, or a file or record in a database. In one embodiment, lock server 330 may be a lock manager in a database management system. If the resource is available, lock server 330 changes the state of the lock for resource 332 to “locked” and returns a response to processor 310 indicating that application 322 is granted access to resource 332.

If the resource is already being accessed by another user, i.e. the state of the lock is already “locked,” then lock server 330 returns the state of the lock to processor 310. Given that resource 332 is locked, application 322 may “spin” on the lock until resource 332 becomes available, meaning application 322 may execute one or more loops and repeatedly check the state of the lock. When the state of the lock becomes “unlocked,” application 322 may then receive the lock and may access resource 332.

In the depicted example, if the service time is long relative to the time it takes to perform a context switch, it may be more efficient for the operating system to perform a context switch to allow application 324 to access processor 310 while application 322 waits for the return response from lock server 330. The lock response may be a reply with the state of the lock or, alternatively, grant of the lock, depending on the lock access protocol of lock server 330.

In an alternative solution, application 322 may retain access to processor 310 until it receives the lock and completes its work, or until operating system gives a time slice to application 324. In yet another solution, application 322 may retain access to processor 310 for a short period of time and relinquish processor 310 if a return response is not received within that period.

Application 322 may make two types of calls to request the lock from lock server 330. A blocking call, also referred to as a synchronous call, is a call in which application 322 continues to access processor 310 while it waits for a return response from lock server 330. A non-blocking call, also referred to as an asynchronous call, is a call in which application 322 may relinquish control of processor 310 while it waits for a return response. When lock server 330 returns a response, processor 310 may generate an interrupt, which may result in operating system 320 performing a context switch to allow application 322 to regain access to processor 310. In other words, after making a non-blocking call, application 322 may relinquish processor 310 and be awoken by operating system 320 when a return response is received.

A key performance optimization question in software design is how to determine the threshold of performing a context switch instead of the alternative of having the requester hold onto the processor while waiting for the service to complete. Apparently, if the device service time is much longer than the time to perform a context switch, the application, as well as the operating system, should favor a context switch. Otherwise, when the device service time is much shorter than the context switch time, using a blocking call and not performing a context switch would result in better performance. Therefore, a reasonable value for the threshold is based on the context switch time of the system.

However, a problem arises when trying to take the context switch time threshold into account in the application design. The decision to perform a blocking or non-blocking call is usually hardwired into the code, implicitly based on an estimate or measurement of the context switch time of a particular operating system and/or hardware configuration. Unfortunately, in reality, the context switch time may vary significantly for different combinations of operating system versions and hardware. For example, with a very fast processor, the context switch time in terms of elapsed wall-clock time can be substantially lower than when a slow processor is used. Therefore, no matter how the software designers determine the elapsed time of the context switch, the decision to perform a blocking or non-blocking call for device service cannot always be optimal because of the variability in context switch time.

Aggravating the problem further, what is compared to the threshold, the device service time or response time, can be even more variable than the context switch time. For example, in a distributed system, a remote service call may encounter queuing delay due to network communication to the remote server and queuing delay of request service at the server. In this case, it is more difficult for the software developer to make judicious or optimal blocking/non-blocking call decisions.

FIG. 4 is a block diagram illustrating a data processing system with multithreading and dynamic context switching decision logic in accordance with an illustrative embodiment operating system 420 executes applications 422, 424 on processor 410. Using multithreading, operating system 420 swaps applications 422, 424 by performing a context switch. For example, application 422 may execute on processor 410 for a period of time, and then operating system 420 may perform a context switch so that application 424 executes on processor 410.

In the depicted example, application 422 submits a request for a lock of resource 432 to lock server 430. Resource 432 may be, for example, a range of memory addresses, an input/output device, or a file or record in a database. In one embodiment, lock server 430 may be a lock manager in a database management system, for example.

In accordance with an illustrative embodiment, operating system 420 maintains context switch time information 442. In one embodiment, context switch time information 442 may simply be a running average of context switch times. In another embodiment, context switch time information 442 may be an array of samples that may be used to calculate a context switch time value. In either case, the software may obtain a context switch time average, which is a meaningful value for the current runtime environment. In the depicted example, “the software” is the software making a dynamic context switching decision, which may be operating system 420 or application 422.

The context switch time value may be a running average of the last N samples, which may be calculated as follows:

$${CT}_{ave} = \frac{( {\sum }_{i = 1}^{N} CT [ i ] )}{N} ,$$

where CTₐᵥₑ is the running average of the context switch time, CT[i] is a recorded context switch time, and N is the size of the window for the running average. For example, the software may keep a running average of the last 100 samples (N=100). Alternatively, the context switch time value may be a weighted average, which may be calculated as follows:

$${CT}_{ave} = \frac{( {\sum }_{i = 1}^{N} i \cdot CT [ i ] )}{{\sum }_{i = 1}^{N} i} ,$$

where CTₐᵥₑ is the weighted average of the context switch time, CT[i] is a recorded context switch time, and N is the number of samples to use in the weighted average. In the exemplary embodiments, a weighted average may weight newer values more heavily. Another technique for computing a weighted average is to simply average a most recent sample with the last calculated value of the weighted average. This may be calculated as follows:

$${CT}_{ave} = \frac{( {CT}_{ave} + CT )}{2} ,$$

where CTₐᵥₑ is the weighted average of the context switch time and CT is a most recently recorded context switch time.

The above equations are provided as examples. The present invention is not intended to be limited to any particular equation for calculating context switch times. Other techniques for determining context switch times will be readily apparent to persons of ordinary skill in the art.

The software may retrieve a response time value. Again, “the software” is the software making a dynamic context switching decision, which may be operating system 420 or application 422. In an exemplary embodiment, lock server 430 may maintain response time information 456. The software may retrieve response time information 456 from lock server 430. Alternatively, operating system 420 may maintain response time information 454, or application 422 may maintain response time information 452.

In a further embodiment, any combination of application 422, operating system 420, and lock server 430 may maintain response time information. For example, operating system 420 may maintain response time information 454 with respect to applications running on processor 410, while lock server 430 may maintain response time information for all users, which may include other applications on other devices within the network. On the other hand, application 422 may maintain response time information 452 with respect to only requests issued from application 422.

In one embodiment, response time information 452, 454, 456 may simply be a running average of response times. In another embodiment, response time information 452, 454, 456 may be an array of samples that may be used to calculate a response time value. In either case, the software may obtain a response time average, which is a meaningful value for the current runtime environment.

Furthermore, response time information 452, 454, 456 may include multiple response time values based on certain attributes of the lock. The software may select an appropriate value to use based on those attributes. For example, response time information 452, 454, 456 may include multiple response time values based on the lock request type—reading requests may have shorter response times than writing requests. As another example, a heuristic may determine what requests are “hot,” e.g., a root of a tree structure may receive more requests than the leaves of the tree structure.

When a blocking call is issued from application 422, operating system 420 may compare an appropriate context switch time value with an appropriate response time value, as described above. For example, operating system 420 may simply compare a running average of the context switch time with a running average of response times. Although, operating system 420 may use more sophisticated techniques for calculating or determining context switch time values and/or response time values.

The comparison may simply be a straight comparison of the context switch time value to the response time value. That is, operating system 420 may simply determine whether the response time value is greater than the context switch time value. Alternatively, operating system 420 may determine whether the response time value is greater than the context switch time value by a predetermined amount. As another example, operating system 420 may determine whether the context switch time value is greater than the response time value by a predetermined amount. As a further example, operating system 420 may determine whether the response time value is a multiple or fraction of the context switch time. Other techniques for comparing the context switch time to the response time will be readily apparent to persons of ordinary skill in the art, and may depend on the software and hardware environment in which the software is implemented.

Operating system 420 then determines whether to perform a context switch based on a result of the comparison. If operating system 420 determines to perform a context switch, operating system 420 grants access to processor 410 to application 424. When a response is received from lock server 430, processor 410 generates an interrupt. Responsive to the interrupt, indicating that the response is received, operating system 420 may then perform a context switch to grant access back to application 422.

If operating system 420 determines not to perform a context switch based on the result of the comparison, application 422 maintains access to processor 410 and spins on the lock until a response is received. Application 422 may then perform more work.

When application 422 issues a non-blocking call, application 422 itself may compare an appropriate context switch time value with an appropriate response time value, as described above. Application 422 then determines whether to perform a context switch based on a result of the comparison. If application 422 determines to perform a context switch, application 422 relinquishes processor 410, and operating system 420 grants to application 424. When a response is received from lock server 430, processor 410 generates an interrupt. Responsive to the interrupt, indicating that the response is received, operating system 420 may then perform a context switch to grant access back to application 422.

If application 422 determines not to perform a context switch based on the result of the comparison, application 422 maintains access to processor 410 and spins on the lock until a response is received. Application 422 may then perform more work.

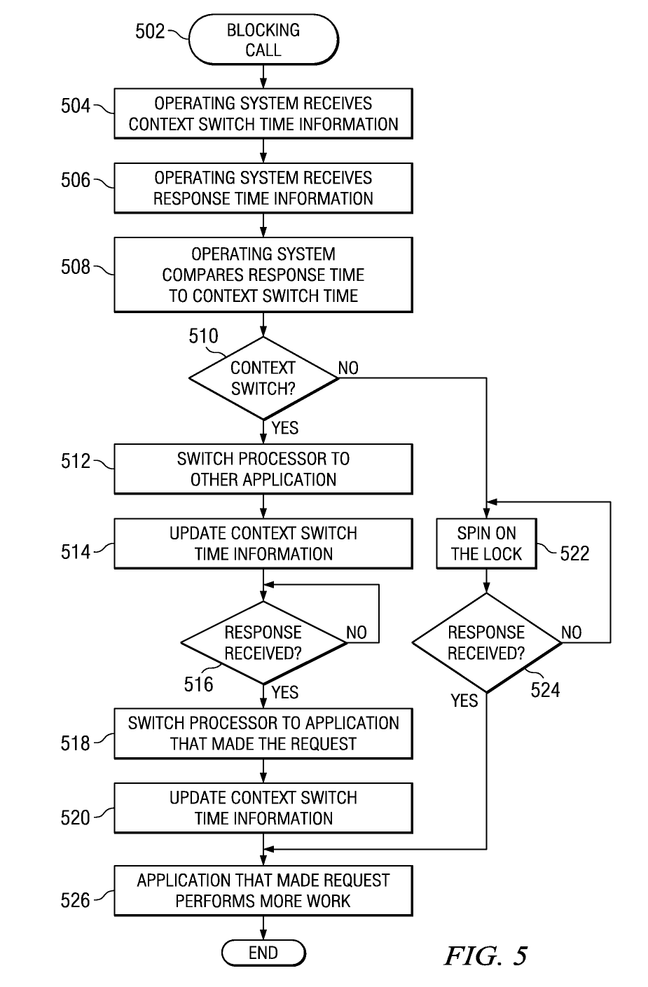

FIG. 5 is a flowchart illustrating operation of an operating system with dynamic context switch decision logic in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With reference now to FIG. 5, operation begins when an application makes a blocking call to request a resource (block 502). The operating system receives context switch time information 504 and receives response time information 506. Context switch time information, particularly context switch time values, may be maintained by the operating system, for example. Response time information, particularly response time values, may be maintained by the application, the operating system, or the resource, such as a lock server, for example.

Given a context switch time value and a response time value corresponding to the blocking call, operating system compares the context switch time value to the response time value (block 508). The operating system determines whether to perform a context switch based a result of the comparison (block 510). If the operating system decides to perform a context switch in block 510, the operating system switches access to the processor to another application (block 512). The operating system then updates the context switch time information (block 514). The operating system may update the context switch time information by recording the context switch time for the most recent context switch, or may calculate a new context switch time value.

Next, the operating system determines whether a response is received for the blocking call (block 516). If a response is not received, operation returns to block 516 and the other application continues to access the processor. If a response is received in block 516, the operating system performs a context switch to switch access to the processor back to the application that made the request (block 518). Then, the operating system updates the context switch time information (block 520). The application that made the request then performs more work using the processor (block 526), and operation ends.

Returning to block 510, if the operating system decides not to perform a context switch, the application spins on the lock 522. The application determines whether a response is received from the resource (block 524). If a response is not received, operation returns to block 522 and the application spins on the lock until a response is received. If a response is received in block 524, the application that made the request performs more work (block 526), and operation ends.

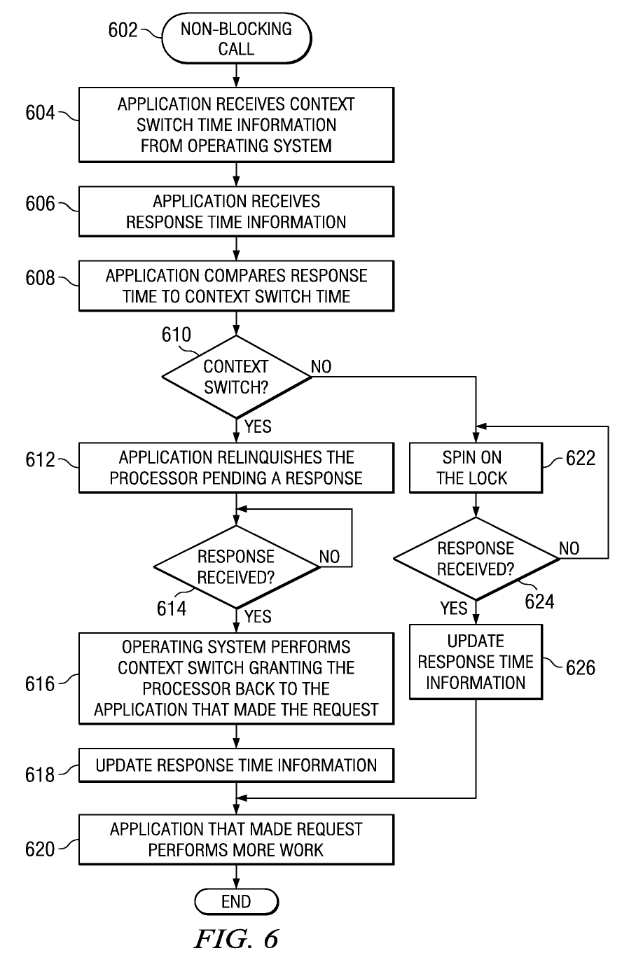

FIG. 6 is a flowchart illustrating operation of an application with dynamic context switch decision logic in accordance with an illustrative embodiment. Operation begins when an application makes a non-blocking call to request a resource (block 602). The application receives context switch time information 604 and receives response time information 606. Context switch time information, particularly context switch time values, may be maintained by the operating system, for example. Response time information, particularly response time values, may be maintained by the application, the operating system, or the resource, such as a lock server, for example.

Given a context switch time value and a response time value corresponding to the blocking call, the application compares the context switch time value to the response time value (block 608). The application determines whether a context switch is to be performed based a result of the comparison (block 610). If the application decides that a context switch is to be performed in block 610, the application relinquishes the processor pending a response from the resource (block 612).

Next, the operating system determines whether a response is received for the blocking call (block 614). If a response is not received, operation returns to block 614 and the other application continues to access the processor. If a response is received in block 614, the operating system performs a context switch to switch access to the processor back to the application that made the request (block 616). Then, the application updates the response time information (block 618). The application that made the request then performs more work using the processor (block 620), and operation ends.

Returning to block 610, if the application decides that a context switch is not to be performed, the application spins on the lock (block 622). The application determines whether a response is received from the resource (block 624). If a response is not received, operation returns to block 622 and the application spins on the lock until a response is received. If a response is received in block 624, the application that made the request updates the response time information (block 626). Then, the application performs more work (block 620), and operation ends.

Thus, the illustrative embodiments solve the disadvantages of the prior art by providing a mechanism in the operating system for recording context switch times. The operating system, the application, or the resource also includes a mechanism for recording response times. At the time of a request, the operating system may compare an average context switch time to an average response time corresponding to the request. The operating system may then decide whether to perform a context switch based on the comparison. Alternatively, the application may receive the average context switch time from the operating system and compare the average context switch time to an average response time corresponding to the request. The application may then decide whether to relinquish the processor or spin on the lock based on the comparison.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for performing dynamic context switch determination, the method comprising:
determining an average context switch time;
determining an average response time;
responsive to a first application running on a processor making a request for a resource, comparing the average context switch time to the average response time; and
determining whether to perform a context switch from the first application to a second application based on a result of the comparison.

2. The method of claim 1, wherein determining an average context switch time comprises calculating a running average or a weighted average of recorded context switch times.

3. The method of claim 1, wherein determining an average response time comprises calculating a running average or a weighted average of recorded context switch times.

4. The method of claim 1, further comprising:
responsive to determining to perform a context switch, granting access to the processor to the second application; and
recording a context switch time for the context switch.

5. The method of claim 4, further comprising:
updating the average context switch time based on the recorded context switch time.

6. The method of claim 1, further comprising:
responsive to a response being received from the resource, granting access to the processor back to the first application; and
recording a response time for the response.

7. The method of claim 6, further comprising:
updating the average response time based on the recorded response time.

8. The method of claim 1, further comprising:
responsive to determining to perform a context switch, the first application relinquishing the processor.

9. The method of claim 1, further comprising:
responsive to determining not to perform a context switch, the first application waiting for a response.

10. An apparatus for performing dynamic context switch determination, the apparatus comprising:
a processor; and
a memory coupled to the processor, wherein the memory contains instructions that, when executed by the processor, cause the processor to:
obtain an average context switch time;
obtain an average response time;
responsive to a first application running on a processor making a request for a resource, compare the average context switch time to the average response time; and
determine whether to perform a context switch from the first application to a second application based on a result of the comparison.

11. The apparatus of claim 10, wherein the instructions further cause the processor to:
responsive to determining to perform a context switch, grant access to the processor to the second application;
record a context switch time for the context switch; and
update the average context switch time based on the recorded context switch time.

12. The apparatus of claim 10, wherein the instructions further cause the processor to:
responsive to a response being received from the resource, grant access to the processor back to the first application;
record a response time for the response; and
update the average response time based on the recorded response time.

13. A computer program product comprising a computer useable medium having a computer readable program, wherein the computer readable program, when executed on a computing device, causes the computing device to:
obtain an average context switch time;
obtain an average response time;
responsive to a first application running on a processor making a request for a resource, compare the average context switch time to the average response time; and
determine whether to perform a context switch from the first application to a second application based on a result of the comparison.

14. The computer program product of claim 13, wherein determining an average context switch time comprises calculating a running average or a weighted average of recorded context switch times.

15. The computer program product of claim 13, wherein determining an average response time comprises calculating a running average or a weighted average of recorded context switch times.

16. The computer program product of claim 13, wherein the computer readable program, when executed on the computing device, further causes the computing device to:
responsive to determining to perform a context switch, grant access to the processor to the second application; and
record a context switch time for the context switch.

17. The computer program product of claim 16, wherein the computer readable program, when executed on the computing device, further causes the computing device to:
update the average context switch time based on the recorded context switch time.

18. The computer program product of claim 13, wherein the computer readable program, when executed on the computing device, further causes the computing device to:
responsive to a response being received from the resource, grant access to the processor back to the first application; and
record a response time for the response.

19. The computer program product of claim 18, wherein the computer readable program, when executed on the computing device, further causes the computing device to:
update the average response time based on the recorded response time.

20. The computer program product of claim 13, wherein the computer readable program, when executed on the computing device, further causes the computing device to:
responsive to determining to perform a context switch, the first application relinquishing the processor.
